(19) United States
(12) Patent Application Publication
(10) Pub. No.: US 2002/0186312 A1
(43) Pub. Date: Dec. 12, 2002

(54) Programmable resolution CMOS image sensor

(76) Inventor: Moshe Stark, Even Yehuda (IL)

Correspondence Address: Eitan, Pearl, Latzer & Cohen-Zedek, Suite 210, One Crystal Park, 2011 Crystal Drive, Arlington, VA, 22202-3709, US

(21) Appl. No.: 09/993,917

(22) Filed: Nov. 27, 2001

Related U.S. Application Data
(60) Provisional application No. 60/252,892, filed on Nov. 27, 2000.

(51) Int. Cl. H04N 5/335

(52) U.S. Cl. 348/302; 348/304

(57) ABSTRACT

An image sensor includes a plurality of unit cells, each adapted to generate charge in response to photons incident thereon and array elements adapted to sum charge from one or more unit cells at a focal plane of the image sensor. Alternatively, the array elements may be adapted to change a resolution of the output of the image sensor at its focal plane. The invention includes the method performed by the image sensor.

### CROSS-REFERENCE TO RELATED APPLICATIONS

This application is related to U.S. Provisional Patent Application, Serial No. 60/252,892, filed Nov. 27, 2000, which is incorporated in its entirety by reference herein

### FIELD OF THE INVNTION

The present invention relates to image sensors generally and to programmable resolution image sensors in particular.

### BACKGROUND OF THE INVETION

Image processing of various types involves trading image resolution against other desired characteristics. For example, image recognition processing speed is highly dependent on the number of processed pixels per frame and therefore, the higher the desired speed, the lower the resolution should be. Similarly, tracking of fast moving objects might dictate frame rates higher than those acceptable to the human eye, such as 30 frames/sec (NTSC) or 25 frames/sec (PAL).

A simple technique to accomplish higher frame rates is called “pixel dilution” and it involves skipping over and reading out every n-th pixel in a row, and every m-th row. This results in a higher frame rate, but also in a lower resolution

More sophisticated methods may involve image processing. In the prior art, the image processing was done away from the focal plane. Recently, with the revival of active pixel sensor (APS)-based CMOS image sensors, there is a tendency to embed image processing functions on the same die with the image sensor, as close as possible to the focal plane or in the focal plane itself.

Much of the work on varying the image sensor's resolution has been performed in the last decade, in context with the APS-photo-gate type image sensors. An image sensor, which is configurable to yield varying resolution images, is a multiresolution image sensor. Such a sensor has row and column averagers, which combine a configurable number of same-row adjacent pixels, and a configurable number of adjacent columns, and output a row/column block average. These averagers are implemented just ahead of the image sensor's video output and follow the data acquisition from the focal plane. The method outputs less “pixels” and therefore allows for higher frame rates. It also “smoothes” the image. The method is less than optimal and has several disadvantages, as follows:

The averaging is performed in proximity to, but not on the focal plane. Provided that focal plane averaging is feasible, there is some Signal to Noise Ratio (SNR) loss involved. Averaging circuitry also produces some SNR loss. SNR loss is not desirable especially for low lighting conditions, where acquisition of a decipherable image is difficult.

The averaging circuits add complexity to the image sensor.

Frame Transfer Image Sensors are also known, which performs the multiresolution function outside of the analog memory array itself. This type of sensor utilizes the fact that the stored charges of adjacent analog memory add “naturally”. Adding the charges rather than averaging them results in an improved SNR, which is very important for weak signals in bad lighting conditions. The disadvantage of this method lies once again in the fact that the charge addition is performed off the focal plane after some loss in the signal strength, and some noise has been added.

### SURMMARY OF THE INVENTION

An object of the present invention is to provide a novel image sensor.

In accordance with a preferred embodiment of the present invention, an image sensor is described which trades resolution for improved SNR and for higher frame rates. The charge or current from a unit cell adds naturally and therefore allows signals to be combined at the focal plane.

Furthermore, the present invention provides an image sensor which can operate in a non-interlace, as well as in an interlace mode. The method allows for an improved SNR at little or no resolution degradation when the sensor operates in interlace mode.

There is therefore provided, in accordance with a preferred embodiment of the present invention, an image sensor which includes a plurality of unit cells, each adapted to generate charge in response to photons incident thereon and array elements adapted to sum charge from one or more unit cells at a focal plane of the image sensor.

There is also provided, in accordance with a second preferred embodiment of the present invention, an image sensor which includes a plurality of unit cells, each adapted to generate charge in response to photons incident thereon and array elements adapted to change a resolution of the output of the image sensor at its focal plane.

Additionally, in accordance with a preferred embodiment of the present invention, the array elements include charge transfer transistors, one per unit cell, a line decoder and a column selector. The charge transfer transistors are adapted to transfer charge from their associated unit cells when activated. The line decoder is adapted to activate charge transfer transistors of one or more lines of unit cells and the column selector is adapted to activate one or more columns of unit cells and to combine the charge transferred by activated charge transfer transistors of the activated columns.

Moreover, in accordance with a preferred embodiment of the present invention, the array elements include an adjacent line unit adapted to indicate to the line decoder to activate at least two adjacent lines and to the column selector to select one column thereby to combine charge from the corresponding unit cells in adjacent lines.

Furthermore, in accordance with a preferred embodiment of the present invention, the array elements include an adjacent column unit adapted to indicate to the line decoder to activate one line and to the column selector to combine charge of at least two columns thereby to combine charge from at least two unit cells in adjacent columns.

Further, in accordance with a preferred embodiment of the present invention, the array elements include a block unit adapted to indicate to the line decoder to activate U adjacent lines and to the column selector to combine charge of V columns thereby to combine charge from U×V unit cells in a U×V block

Still further, in accordance with a preferred embodiment of the present invention, the image sensor also includes an interlace unit adapted to produce video output from the image sensor in an interlace mode. The interlace unit includes a unit adapted to activate the adjacent line unit to combine charge of pairs of unit cells in adjacent lines beginning with the odd lines for an odd field output and of adjacent lines beginning with the even lines for an even field output.

Moreover, in accordance with a preferred embodiment of the present invention, the image sensor also includes an intercolumn unit adapted to produce video output from the image sensor in an intercolumn mode. The intercolumn unit includes a unit adapted to activate the adjacent column unit to combine charge of pairs of adjacent columns beginning with the odd columns for an odd field output and of adjacent columns beginning with the even columns for an even field output.

Further, in accordance with a preferred embodiment of the present invention, the image sensor includes a block interlace unit adapted to produce video output from the image sensor in a block interlace mode. The block interlace unit includes a unit adapted to activate the block unit to combine charge of 2×2 blocks wherein the blocks of an odd field output begin with the block whose upper left-hand unit cell is in the first column, first line and wherein the blocks of an even field output begin with the block whose upper left-hand unit cell is in the second column, second line.

Finally, the present invention includes the methods performed by the image sensor.

### BRIEF DESCRIPTION OF THE DRAWINGS

The present invention will be understood and appreciated more fully from the following detailed description taken in conjunction with the appended drawings in which:

FIG. 1 is a circuit diagram illustration of a portion of an image sensor, constructed and operative in accordance with a preferred embodiment of the present invention, showing two unit cells from two adjacent lines and elements for sensing their charge;

FIG. 2 is a circuit diagram illustration of a portion of an image sensor, constructed and operative in accordance with a preferred embodiment of the present invention, showing two unit cells from two adjacent columns and elements for sensing their charge;

FIG. 3 is a block diagram illustration of one embodiment of the image sensor of the present invention;

FIGS. 4A, 4B and 4C are schematic illustrations of three modes of generating programmable resolution;

FIGS. 5A, 5B and 5C are schematic illustrations of three modes of achieving interlace signals using the image sensor of the present invention;

FIG. 6 is a block diagram illustration of a further embodiment of the image sensor of the present invention;

FIG. 7 is a block diagram illustration of a line decoder forming part of the image sensor of FIG. 6;

FIG. 8 is a block diagram illustration of a column selector decoder forming part of the image sensor of FIG. 6; and

FIG. 9 is a block diagram illustration of a video multiplexer forming part of the image sensor of FIG. 6.

### DETAILED DESCRIPTION OF THE PRESENT INVENTION

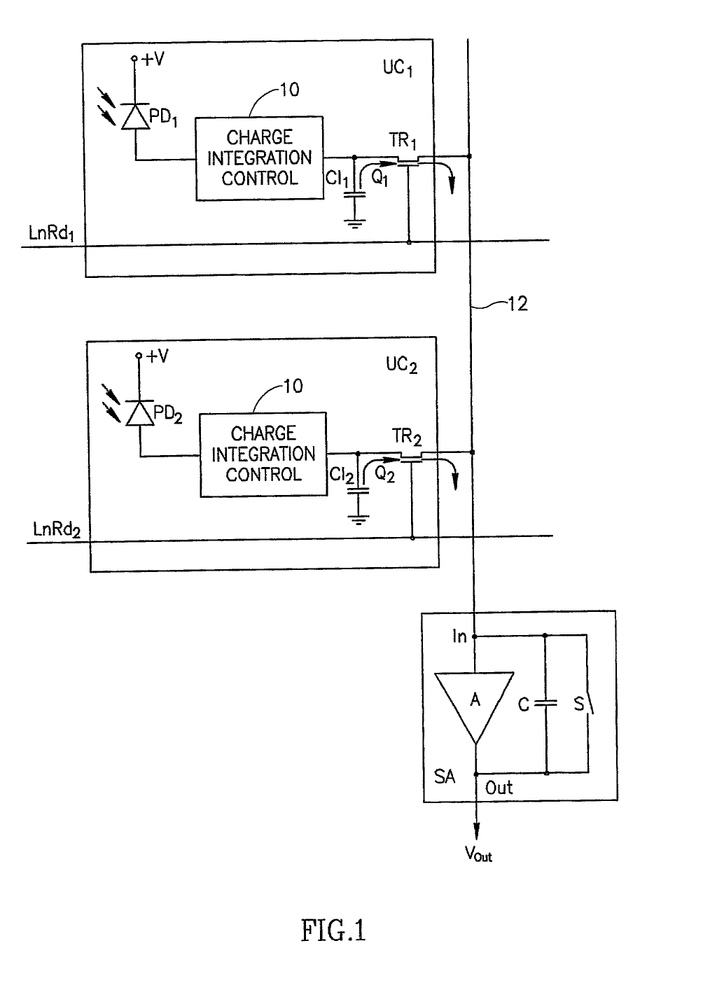

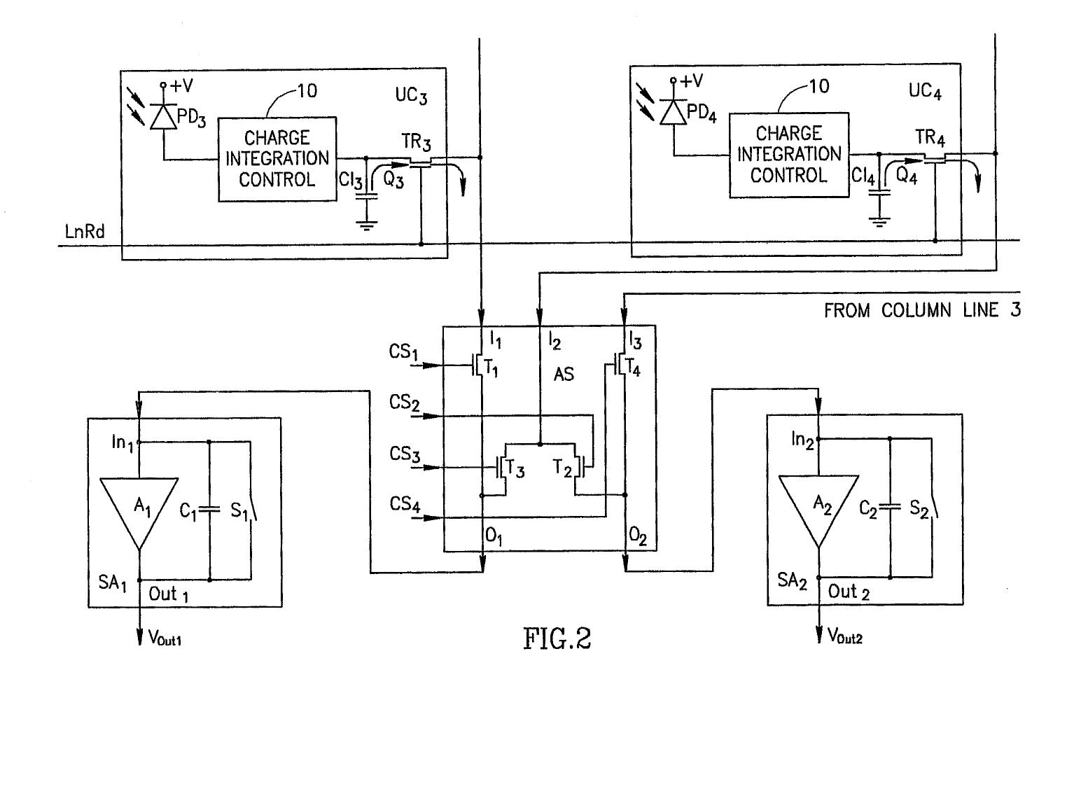

Reference is now made to FIG. 1 and 2, which illustrate two alternative embodiments of the present invention. Both figures show two adjacent unit cells, where the two unit cells in FIG. 1 are in the same column and the two unit cells of FIG. 2 are in the same row. Both unit cells are of the direct injection, charge-sensing type.

In the present invention, the charge of adjacent cells may be separately sensed or may be combined, as desired. When the charge is separately read, the resolution is high (i.e. there are more pixels). When the charges are combined, the resolution is lower (i.e. fewer pixels); however, the signal to noise ratio (SNR) is much higher in this latter case than for the higher resolution case.

As can be seen in FIGS. 1 and 2, described in more detail hereinbelow, the programmable resolution function is combined with the sense function, at the output of the unit cells. Therefore, the noise contribution to the video signal is minimal Furthermore, the present invention improves the signal to noise ratio since it simply adds the charge or current of adjacent unit cells rather than averaging the charge or current.

FIGS. 1 and 2 depict two “adjacent” unit cells UC₁ and UC₂. These unit cells are Direct Injection (DI)—Charge-Sensing Unit Cells. “Adjacent” is defined as being located near each other in the array and meeting the following conditions:

Let Q₁ and Q₂ be the charge signals accumulated in adjacent unit cells, UC₁ and UC₂, respectively. Then

$$\begin{matrix}{Q}_{1} = \overline{Q} + ϵ & ( 1 ) \\ {Q}_{2} = \overline{Q} - ϵ \\ where , & ( 2 ) \\ \overline{Q} = \frac{{Q}_{1} + {Q}_{2}}{2} \\ and , & ( 3 ) \\ ϵ = \frac{{Q}_{1} - {Q}_{2}}{2} & ( 4 ) \\ \vert \frac{ϵ}{\overline{Q}} \vert << 1 & ( 5 )\end{matrix}$$

Same Column/Adjacent Rows

FIG. 1 depicts two adjacent unit cells UC₁ and UC₂ located in the same column and in two adjacent rows. Each cell comprises a photodetector PDᵢ, a charge integration control unit 10, a charge integration capacitor CIᵢ and a charge readout transistor TRᵢ. Transistors TRᵢ are controlled by line read signals LnRdᵢ and the array includes a sense amplifier SA per every two unit cells UC, connected to the output of the transistors TRᵢ via a column line 12.

Each photodetector PD is light sensitive and produces a photocurrent proportional to the intensity of light. Each control circuit 10 controls the photocurrent charge integration period (or exposure time) over each integration capacitor CI. Following the image acquisition, which occurs during exposure, the charge stored in each integration capacitor CI is proportional to the photocurrent and length of exposure. The charge stored in each integration capacitor CI is then read out. A transition on the relevant LnRd signal from “0” to “1” causes the relevant readout transistor TR to turn ON, which results in readout of the stored charge. In other words, the charge stored on the relevant integration capacitor CI is transferred via column line 12 to sense amplifier SA.

It will be appreciated that the present invention incorporates any operation that causes a readout transistor to be turned on. This can be a transition to “1” for an n-channel type transistor or a transition to “0” for a p-channel type transistor.

Sense amplifier SA is a charge integration amplifier and comprises an amplifier A, a charge integration capacitor C and a switch S that resets the capacitor C (e.g. reduces the capacitor's charge to zero). To achieve the highest resolution, the charges Q₁ and Q₂ are readout separately. For instance, providing a transition on LnRdᵢ signal causes readout transistor TR₁ of unit cell UC₁ to transfer charge Q₁ from integration capacitor CI₁ to sense amplifier SA. At the end of charge transfer process, charge Q₁, resides on capacitor C. Accordingly, the output voltage Vₒᵤₜ₁ of sense amplifier SA is, for unit cell UC₁:

$$\vert {V}_{out1} \vert = \frac{1}{C} \cdot \vert {Q}_{1} \vert \qquad ( 6 )$$

If the RMS voltage noise signal is eₙᵢ, then the signal to noise ratio of the output of sense amplifier S is, for unit cell UC₁:

$$S N {R}_{1} = \frac{\vert {V}_{out1} \vert}{{e}_{n1}} \qquad ( 7 )$$

Similarly, if there is a transition on line read signal LnRd₂ of unit cell UC₂, the output voltage Vₒᵤₜ₂ is:

$$\begin{matrix}\vert {V}_{out2} \vert = \frac{1}{C} \cdot \vert {Q}_{2} \vert \\ and , & ( 8 ) \\ S N {R}_{2} = \frac{\vert {V}_{out2} \vert}{{e}_{n2}} & ( 9 )\end{matrix}$$

where eₙ₂ is the RMS voltage noise for charge Q₂ and SNR₂ is the corresponding signal to noise ratio.

For adjacent pixels,

$$\begin{matrix}\vert {V}_{out2} \vert ≅ \vert {V}_{out1} \vert = \vert {\overline{V}}_{out} \vert = \frac{1}{C} \cdot \vert \overline{Q} \vert \\ and , & ( 10 ) \\ {e}_{n1} ≅ {e}_{n2} ≅ {e}_{n} & ( 11 ) \\ S N {R}_{1} ≅ S N {R}_{2} ≅ S N R & ( 12 )\end{matrix}$$

Higher frame rates can be accomplished by pairing pixels in the same column, and simultaneously reading out the accumulated charge in two adjacent unit cells. The unit cells UC₁ and UC₂ can be read out at the same time by providing a transition on line read signals LnRd₁ and LnRd₂ at generally the same time, thus causing transistors TR₁ and TR₂ to turn ON generally simultaneously. The accumulated charges Q₁, and Q₂ are transferred from unit cells UC₁ and UC₂ into the capacitor C of sense amplifier SA. Therefore, the signal voltage Vₒᵤₜ is,

$${V}_{out} = \frac{1}{C} \cdot \vert {Q}_{1} + {Q}_{2} \vert = \frac{2}{C} \cdot \vert \overline{Q} \vert \qquad ( 13 )$$

In other words, the output signal is twice as large when two adjacent unit cells are read out generally simultaneously in comparison to when each cell is read out separately.

For uncorrelated noise sources en₁ and en₂, the equivalent RMS voltage noise source when simultaneously read is,

$${e}_{n} = \sqrt{{e}_{n1}^{2} + {e}_{n2}^{2}} = \sqrt{2} \cdot {e}_{n} \qquad ( 14 )$$

Therefore the signal to noise ratio SNR_{2,1} when two adjacent rows/same column pixels are read out simultaneously is:

SNR_{2,1=√}\sqrt{2}·SNR (15)

It will be appreciated that summing the signals accumulated in two adjacent unit cells during a single exposure results in an improvement in the signal to noise ratio by a factor of \sqrt{(2)}. This involves a reduction in the vertical resolution and an increase in readout rate by a factor of 2.

Same-Row/Adjacent Columns

FIG. 2 depicts two unit cells UC₃ and UC₄ in the same row but in two adjacent columns, two sense amplifiers SA₁ and SA₂ and an amplifier selector AS. Each unit cell UC₃ and UC₄ has the same elements as the unit cells of FIG. 1 and will not be described further. Each sense amplifier SA₁ and SA₂ has the same elements as the sense amplifier of FIG. 1 and will not be described further. Amplifier selector AS operates to steer charge from unit cells UC₃ and UC₄ into sense amplifiers SA₁ and SA₂ and comprises four select transistors T₁, T₂, T₃, and T₄ that are controlled by control signals CS₁, CS₂, CS₃ and CS₄, respectively.

Select transistors T₁ and T₄ connect the column lines 1 and 3, respectively, directly to sense amplifiers SA₁ and SA₂, respectively. Select transistors T₂ and T₃ connect column line 2 to either sense amplifier SA₁ or SA₂.

For the highest resolution, the charge from each unit cell UCᵢ is read by separate sense amplifiers SAᵢ. Control signals CS₁ and CS₄ are set to activate select transistors T₁ and T₂ and to deactivate select transistors T₃ and T₄. Thus, the charge stored in unit cell UC₃ is read out through transistor TR₃ to column line 1, through select transistor T₁ in amplifier selector AS to sense amplifier SA₁. Similarly, the charge stored in unit cell UC₄ is read through transistor TR₄ to column line 2, through select transistor T₂ to sense amplifier SA₂. The charges Q₃ and Q₄ are read out generally simultaneously by sense amplifiers SA₁ and SA₂.

Faster readout can be accomplished by combining the charge of the two adjacent same-row pixels into a single sense amplifier. For the case depicted in FIG. 2, charges Q₃ and Q₄ are read into sense amplifier SA₁, while sense amplifier SA₂ is not used. This is achieved by pulling providing a transition on the LnRd signal while generally simultaneously turning on select transistors T₁ and T₃. Select transistors T₂ and T₄ stay in the OFF condition. Table 1 lists the valid states for the four select transistors T₁, T₂, T₃ and T₄.

TABLE 1

| Select Signal Combination | | | | Connection | | |
|---|---|---|---|---|---|---|
| CS₁ | CS₂ | CS₃ | CS₄ | In1 | In2 | In3 |
| “0” | “0” | “0” | “0” | None | None | None |
| “1” | “1” | “0” | “0” | O₁ | O₂ | None |
| “1” | “0” | “1” | “0” | O₁ | O₁ | None |
| “0” | “1” | “0” | “1” | None | O₂ | O₂ |

It will be appreciated that when the charge of two adjacent unit cells of the same row are combined, the resolution of the resultant image is half of that if no charge is combined. Furthermore, only generally half of the sense amplifiers contain row information. Therefore, the line readout time is twice as fast. This will also result in halving the entire frame readout time.

A similar SNR analysis to the one performed for the embodiment of FIG. 1 yields a similar result-,

SNR_{3,4}=\sqrt{2}SNR (16)

where SNR_{3,4} is the signal to noise ratio when the charge of two adjacent same-row unit cells UC₃ and UC₄ are combined into a single sense amplifier while SNR is the signal to noise ratio when charge of one unit cell is read out into an individual sense amplifier.

A Block of U-Rows/V-Columns

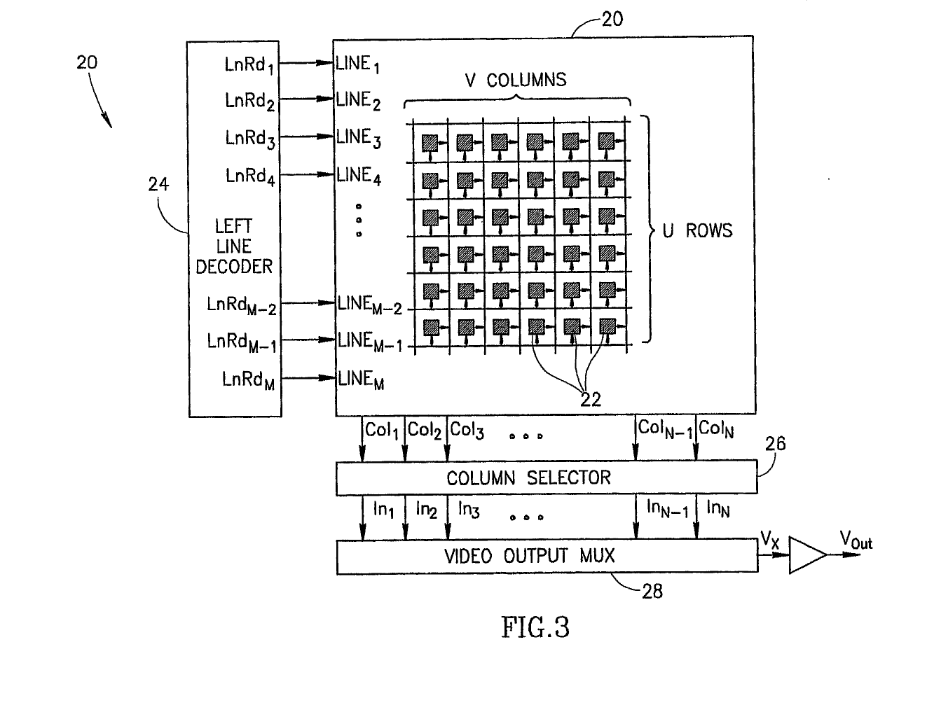

Reference is now made to FIG. 3, which is a general schematic of an image sensor 20, constructed and operative in accordance with a preferred embodiment of the present invention. Image sensor 20 comprises a multiplicity of unit cells 22, such as the ones described hereinabove with respect to FIGS. 1 and 2, a line decoder 24, a column selector 26 and a video output multiplexer (MUX)28.

Line decoder 24 is capable of selecting, generally simultaneously, a group of U rows where U is a programmable number. Thus, in the first readout cycle, line read signals LnRd₁ to LnRdᵤ have transitions thereon while the remaining lines do not. During the next readout cycle, line read signals LnRdᵤ₊₁, to LnRd₂ᵤ have transitions thereon while the remaining lines do not, and so on.

Column selector 26 is capable of selecting, generally simultaneously, a group of V columns where V is a programmable number. Thus, the first V Unit Cells UC₁ to UCᵥ are generally simultaneously read out to the first sense amplifier SA₁, the second V Unit Cells UC_{V+1}, to UC_{2V} are simultaneously read out to sense amplifier SA_{V+1}, and so on.

Video output MUX 28 outputs the signal from a single sense amplifier to the video output. MUX 28 is programmed to produce the outputs of those sense amplifiers that contain valid information, that is, SA₁, SA_{V+1}, SA_{2V+1} and SA_{NV+1}.

Image sensor 20 operates by reading U×V blocks at a time to a single sense amplifier (i.e. the charge of the unit cells in the block are combined and are read by the sense amplifier for the block). U and V are programmable numbers, which control the operation of line decoder 24, column selector 26 and video MUX 28.

For the sake of simplicity, assume that M is divisible by U, and N is divisible by V. We define the following variables:

T_{Pelk} is the basic unit cell clock period, used for readout. Thus readout from a single sense amplifier is performed in a single unit cell clock period.

T⁰_{Rd} is the readout time for the entire array for the highest resolution case (i.e. each unit cell is individually read into a separate sense amplifier). For this case:

T^{O}_{Rd}=M·N·T_{Pelk} (17)

T^{U,V}_{Rd} is the readout time for a U×V block into a single sense amplifier.

$$\begin{matrix}{T}_{R d}^{U , V} = \frac{M}{U} \cdot \frac{N}{V} \cdot {T}_{P C l k} \\ or , & ( 18 ) \\ {T}_{R d}^{U , V} = \frac{{T}_{R d}^{O}}{U \cdot V} & ( 19 )\end{matrix}$$

When the stored information is read in U X V blocks, the readout time is reduced by a factor of U*V, the horizontal resolution is reduced by a factor of V, and the vertical resolution by a factor of U.

The signal to noise ratio can determined for two cases, a variable frame rate and a fixed frame rate. Variable Frame Rate: In some applications, such as the acquisition of images of moving object, a variable frame rate is important. When an object is approaching the camera, its angular speed is higher. Therefore, for fast moving objects, more frames per second is essential. The present invention provides this, without unit cell dilution.

In this case, multi-resolution is applied to increase the frame readout. For this case,

$$\begin{matrix}T = \frac{{T}_{R d}^{O}}{U \cdot V} + {T}_{I} \\ and , & ( 20 ) \\ F R = \frac{1}{T} & ( 21 )\end{matrix}$$

where,

T_{I}—is the charge integration time,

T—is the frame cycle time,

FR—is the frame rate.

Formula (20) indicates that higher frame rates can be traded for lower resolutions. The signal to noise ratio SNR_{u,v} can be also derived,

SNR_{U,V}=\sqrt{U·V}SNR (22)

where SNR is the signal to noise ratio for the highest resolution.

As can be seen, when the unit cells are readout in U×V blocks, the signal to noise ratio improves by a factor of \sqrt{(U*V)}.

Fixed Frame Rate: For still video, poor lighting conditions, or when a compressed picture form is desirable (for the sake of saving picture storage space), one may utilize the multi-resolution of the present method to improve the sensitivity of the SNR For real-time video either displayed on a TV or on a computer monitor, the frame rate is fixed. For this case, the maximum charge integration time is determined by the frame rate and by the readout time, where T⁰_{I,max} is the maximum integration time for the case where each unit cell is individually read.

$${T}_{l , max}^{O} = \frac{1}{F R} - {T}_{R d}^{O} \qquad ( 23 )$$

Reading out the video in U×V blocks reduces the readout time by a factor U*V and therefore allows charge integration time to be increased.

$${T}_{l , max}^{U , V} = \frac{1}{F R} - \frac{{T}_{R d}^{O}}{U \cdot V} \qquad ( 24 )$$

Since the signal to noise ratio improves as a square root of the integration charge time, the improvement of the SNR for the fixed frame rate SNR^{FFR}_{U,V} is governed by

$${SNR}_{U , V}^{FFR} = \sqrt{\frac{U \cdot V - FR \cdot {T}_{Rd}^{O}}{1 - FR \cdot {T}_{Rd}^{O}}} \cdot SNR \qquad ( 25 )$$

For example, for an image sensor which operates at a fixed frame rate of 30 frames/sec with a 16 msec readout time at the highest resolution has a reduction in horizontal and vertical resolution by a factor of 2 and an improvement in the signal to noise ration by a factor of 2.6.

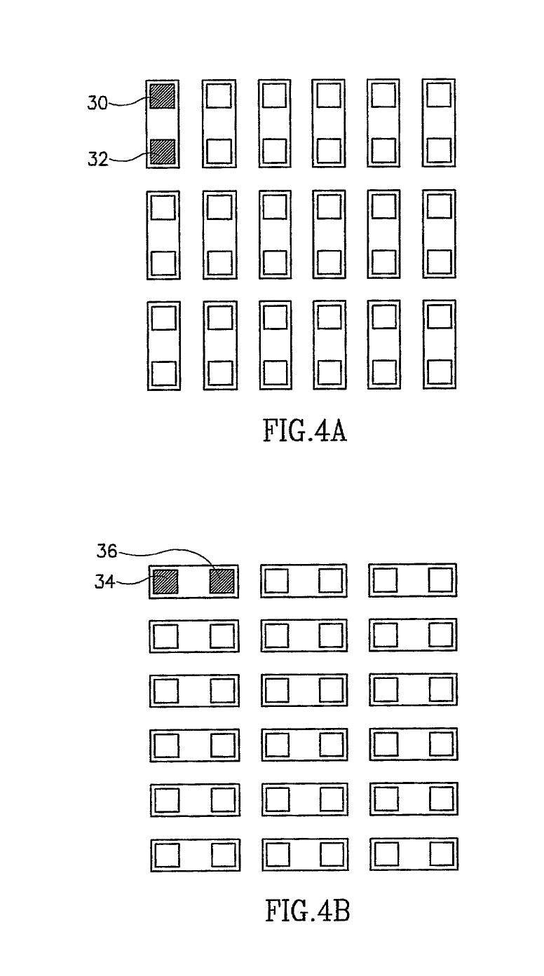

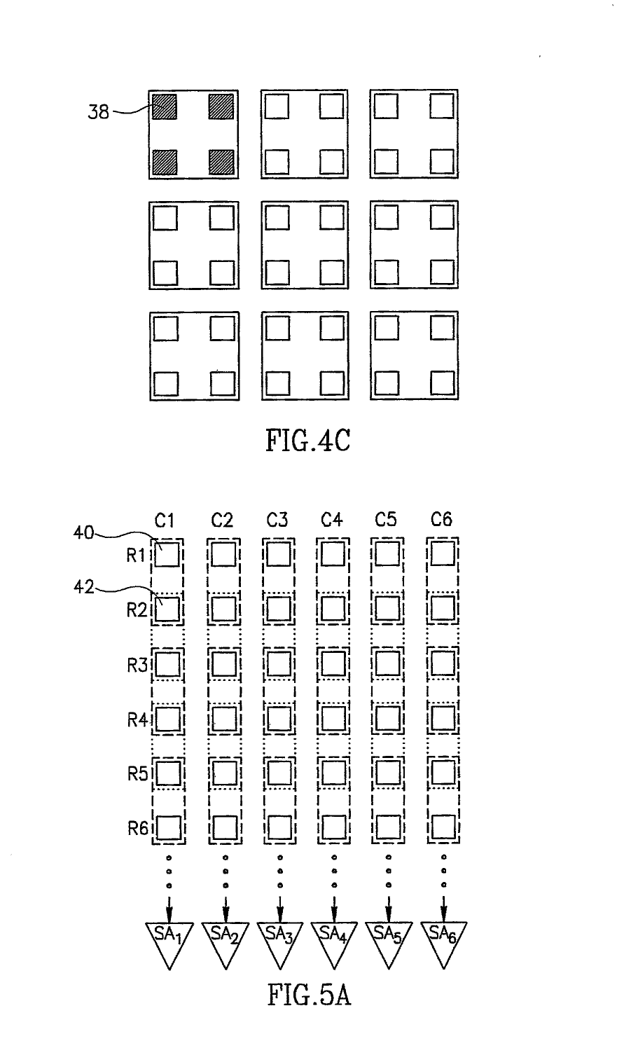

Image sensor 20 is capable of programmable resolution Reference is now made to FIGS. 4A, 4B, 4C and 4D, which illustrate its operation for four different cases.

FIG. 4A illustrates the highest horizontal resolution but half the vertical resolution The charge from two unit cells 30 and 32 in the same column but in adjacent rows is generally simultaneously transferred into the same sense amplifier. This corresponds to the case of FIG. 1. The number of lines to be read is half the maximum number while the number of unit cells per line is maximal To display a full-size picture on a video display, each line of data must be repeated twice. This is normally done from an external frame buffer and not from the image sensor directly.

FIG. 4B illustrates the highest vertical resolution but half the horizontal resolution. The charge from two unit cells 34 and 36 in the same row but adjacent columns is generally simultaneously read into a single sense amplifier. This corresponds to the case of FIG. 2.

FIG. 4C depicts the case for which the resolution is reduced by a factor of two both horizontally and vertically. Thus, the charge from a 2×2 block 38 is combined into one sense amplifier via two adjacent column lines. This results in significant SNR improvement.

The embodiments of FIGS. 4A, 4B and 4C show combining unit cells of two lines and/or two columns. It will be appreciated that the present invention incorporates the embodiments of FIGS. 4A, 4B and 4C as well as all other embodiments combining multiple lines and/or multiple columns.

Programmable Resolution, Interlace-Mode Image Sensors

TV displays and often computer monitors operate in an interlace mode. This requires that the frame readout be performed in odd and even field sub-cycles where, during the odd field sub-period, the odd lines are readout, while during the even field sub-period, the even lines are readout. The term “interlaced” indicates that the even lines are located in between the odd lines.

In the present invention, a simple way to generate an interlaced signal is by the acquisition of lines 1, 3, 5. 7, . . . for the odd field while reading out the previous even field data and then reading out the odd field data while acquiring the even lines 2, 4, 6, 8, . . . for the even field, and so on.

Since each field readout time is half the frame readout time, this results in the reduction of the maximum integration time by a factor of two.

Therefore,

$$SNRI = \frac{1}{\sqrt{2}} \cdot SNR \qquad ( 26 )$$

where SNRI_{2,1} is the signal to noise ratio for the interlaced image sensor, SNR is the SNR for a conventional sequential, frame-type image sensor programmed to its highest resolution.

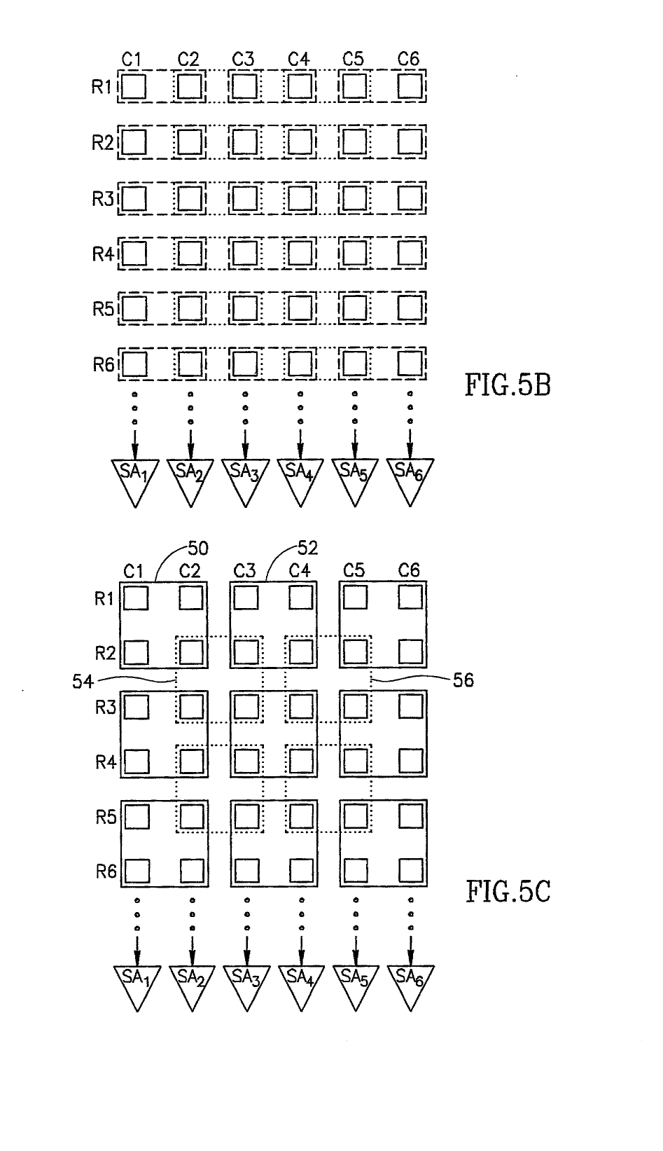

Reference is now made to FIG. 5A, which illustrates the operation of the present invention in interlace mode. For the odd field, the charges from two vertically adjacent unit cells 40 and 42 in lines R1 and R2 are combined (as noted by the dashed box around them) and simultaneously transferred to the sense amplifier for that column, SA₁, in a manner similar to that described with respect to FIG. 1. This is true for all unit cells in lines R1 and R2 (i.e. charges from two vertically adjacent unit cells of column C2 are combined and simultaneously transferred to the sense amplifier for that column, SA2, etc.). This is followed by a similar action for lines R3 and R4, followed by lines R5 and R6, and so on, until the last two lines.

The odd field readout is followed by the readout of the even field. The even field data acquisition is generally simultaneous with the odd field readout. The even field readout involves pairing of lines R2 and R3 (as indicated by the dotted box around the unit cells), followed by lines R4 and R5, followed by lines R6 and R7, and so on.

For this mode of operation the signal to noise ratio SNRI_{2,1} is,

SNRI_{2,1}=SNR (27)

and,

SNRI_{2,1}=\sqrt{2}·SNRI (28)

Reference is now briefly made to FIG. 5B, which illustrates horizontal field interlacing, in a method called intercolumn mode. This is accomplished by combining charge from columns C1 and C2 into sense amplifier SA₁, that of columns C3 and C4 into sense amplifier SA₃, that of columns C5 and C6 into sense amplifier SA₅, etc. and reading out the acquired data during the odd field time period. The even field data readout follows by steering columns C2 and C3 into sense amplifier SA₂, columns C4 and C5 into sense amplifier SA_{4,} columns C6 and C7 into SA₆ and reading out the acquired data during the even field time period. This mode yields almost the same resolution as the non-interlaced/highest-resolution mode, since the number of unit cells per line is effectively the same.

The method can be used in the context of non-interlaced displays, if an external video buffer is used to reorder the frame in a way suitable for a display, that is, that the odd “pixel” which combines columns j and j+1 will be followed by the same-line adjacent even “pixel” which combines columns j+1, and j+2. While this method does not have any SNR advantages over the standard, non-interlace/highest resolution mode, it does result in further SNR gains, no resolution cost and almost no hardware complications.

FIG. SC shows a further interlace method where each output “pixel” is formed from a 2×2 block of unit cells. The odd field begins with block 50 having the unit cells from adjacent columns beginning with the odd columns (i.e. columns 1, 3, 5, etc) and adjacent lines beginning with the odd lines (i.e. lines 1, 3, 5). Thus, block 50 has unit cells (R1, C1), (R1, C2), (R2, C1) and (R2, C2). The next block, block 52, has unit cells R1, C3), (R1, C4), (R2, C3) and (R2, C4). The even field begins with block 54 having the unit cells from adjacent columns beginning with the even columns (i.e. columns 2, 4, 6, etc) and adjacent lines beginning with the even lines (i.e. lines 2, 4, 6). Thus, block 54 has unit cells (R2, C2), (R2, C3), (R3, C2) and (R3, C3). The next block, block 56, has unit cells (R2, C4), (R2, C5), (R3, C4) and (R3, C5).

It is noted that displays are designed to correctly position the even lines between the odd lines. However, there is no mechanism that positions the even columns between the odd columns. Therefore, the image sensor must be designed to account for this. For example, for the even field, and the horizontal interlace mode, the image sensor must delay all the lines by one additional unit cell clock period Tₚₑₗₖ.

It is also noted that the description hereinabove assumes that M and N are even numbers. Therefore, there is one less row and one less column in the even field compared to the odd field. If N or M are odd, the number of rows or the number of columns, respectively, will be the same for the two fields.

The method of FIG. 5C produces almost the same horizontal and vertical resolution as an image sensor operating in a non-interlace/highest-resolution mode; however, the method of FIG. 5C has a better SNR. The maximum integration time is no different than for the interlaced mode, as described for the case depicted in FIG. 5A. However, the method of FIG. 5C provides a signal with twice the magnitude. This, of course, results in an improved SNR-,

SNRI_{2,2}=\sqrt{2}·SNR (29)

and,

SNRI_{2,2}=2SNRI (30)

where SNRI_{2,2} is the signal to noise ratio for FIG. 5C, in which the charge of four adjacent unit cells are combined into a single sense amplifier.

The present invention has been described for direct injection (DI) type of unit cells, which are based upon charge readout. The present invention also applies to unit cells that are based upon current readout.

The present invention is not limited to summing up the output of two vertically adjacent or two horizontally adjacent unit cells. As described in the context of FIG. 3, any rectangular block of neighboring pixels charges can be added in non-interlace or interlace modes. This reduces the resolution and results in a higher frame rate and an improved SNR, but adds to the hardware complexity.

It will be appreciated that the present invention is unique in that it adds charge right in the focal plane. This results in a lower noise compared to methods for which this is done later in the signal chain. It also results in a stronger signal coming out of the array, and therefore in an improved SNR.

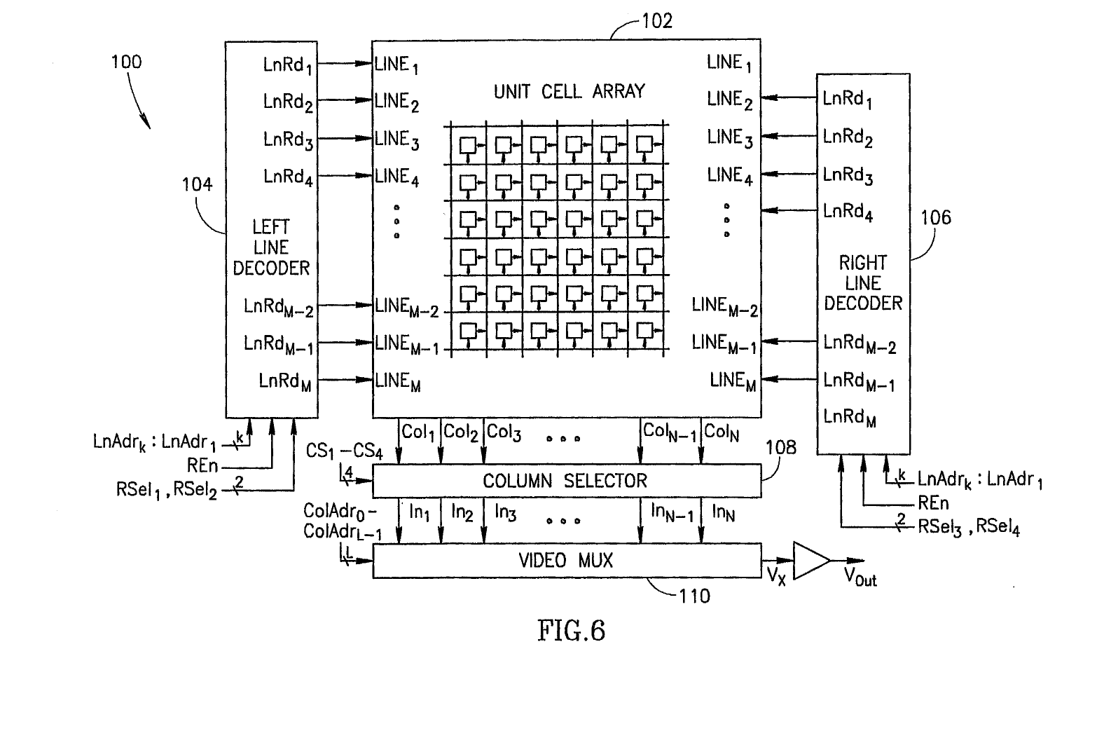

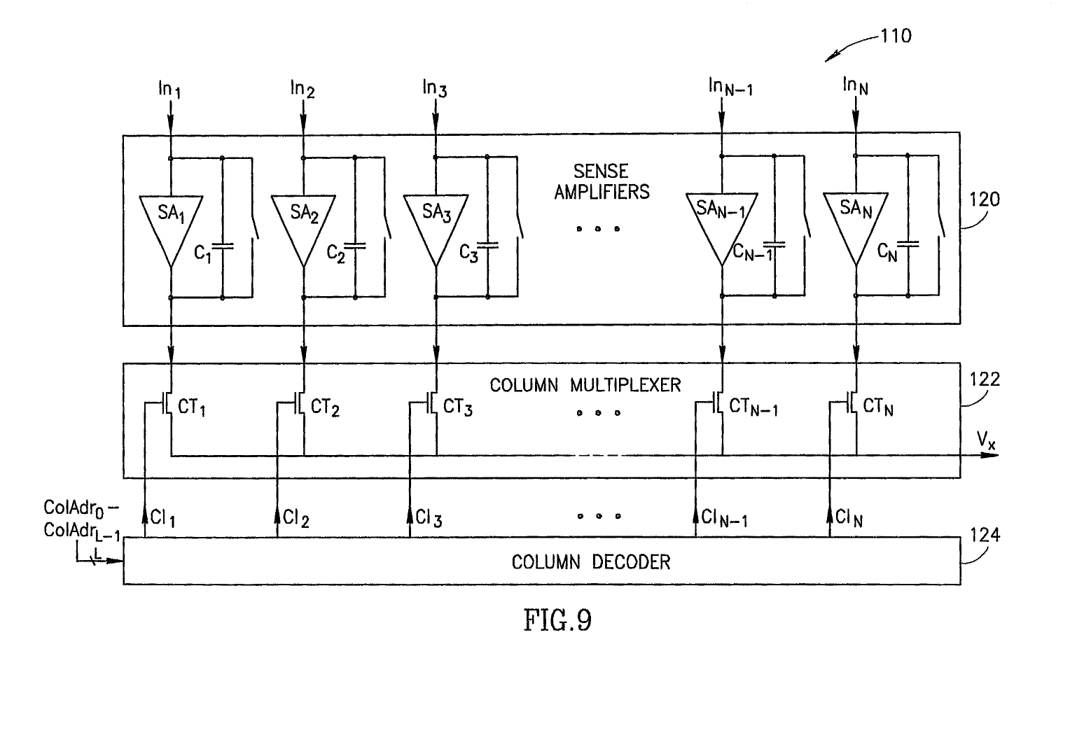

Reference is now made to FIGS. 6, 7, 8 and 9, which illustrate various elements necessary to control the image sensor, and its different modes of operation, described hereinabove. FIG. 6 illustrates an image sensor 100, constructed and operative in accordance with a preferred embodiment of the present invention and using the methods described hereinabove with respect to FIGS. 1-5, FIG. 7 illustrates a line decoder, FIG. 8 illustrates a column selector and FIG. 9 illustrates a video multiplexer. The implementations described hereinbelow are not the only alternatives and all embodiments are incorporated in the present invention.

In accordance with the principles outlined hereinabove, image sensor 100 is fully programmable and can operate in either the interlace or non-interlace mode, and at full or partial resolution, but with significantly improved SNR and readout. Moreover, the programming may be independently performed for the horizontal and the vertical directions.

Image sensor 100 comprises a unit cell array 102, left and right line decoders 104 and 106, respectively, a column selector 108 and a video multiplexer 110. Left and right line decoders 104 and 106 are typically implemented with the same structure, where each decoder has M line read LnRdᵢ output signals; however, right line decoder 106 is shifted down by one line. Thus, LnRd₁ for left line decoder 104 is connected to line 1 of the array while LnRd₁ for right line decoder 106 is connected to line 2 of the array, and so on. For right line decoder 106, LnRd_{M} is not connected to any line. Lines 2-M of the array are connected to both line decoders 104 and 106 while line 1 is connected to left line decoder 104 only. This arrangement facilitates both the non-interlace and the interlace modes of operation.

For the non-interlace mode, the line readout operation is wholly governed by left line decoder 104.

For the odd field of the interlace mode, the operation is governed by left line decoder 104 and the lines are read out in pairs. Thus, readout of lines 1 and 2 is followed by lines 3 and 4, etc. until lines M-1 and M.

For the even field the operation is governed by right line decoder 106. Right line decoder 106 performs the same operation as for the odd field but the output is shifted due to right line decoder 106 being connected to the array starting at line 2 rather than at line 1 as for left line decoder 104. Thus, readout of lines 2 and 3 is followed by readout of lines 4 and 5, etc. until lines M−2and M−1.

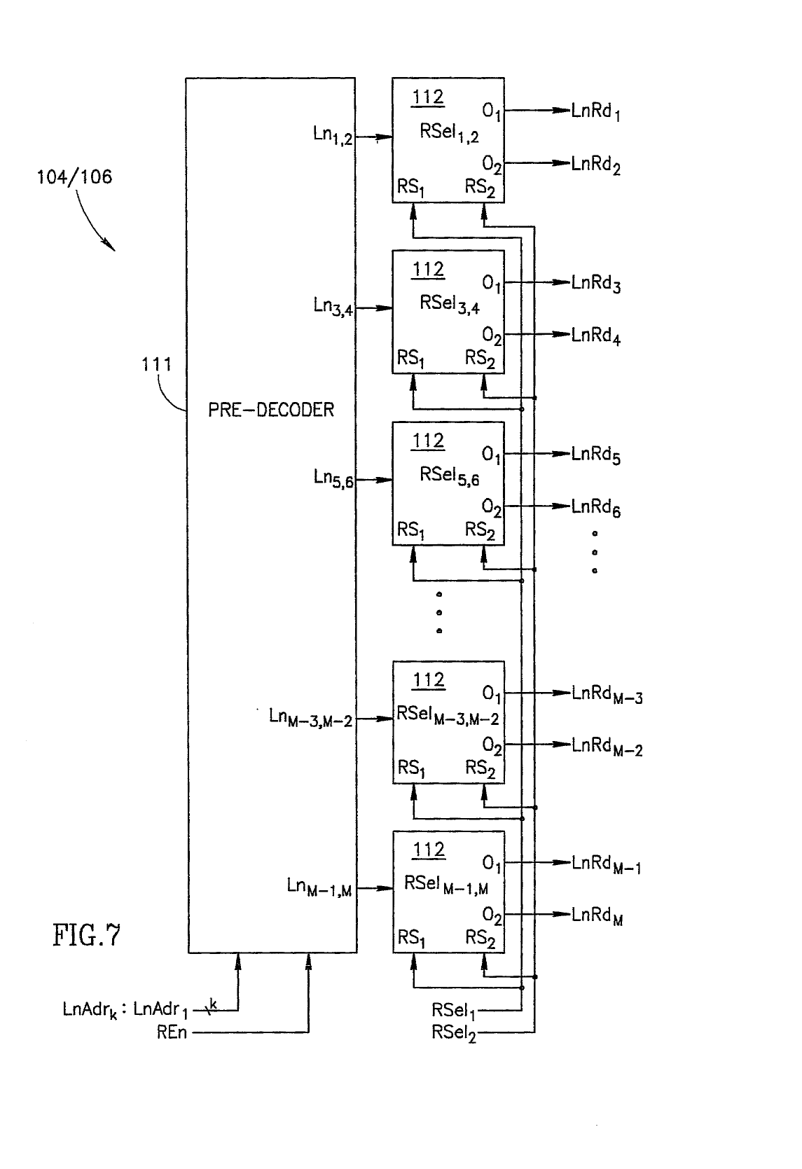

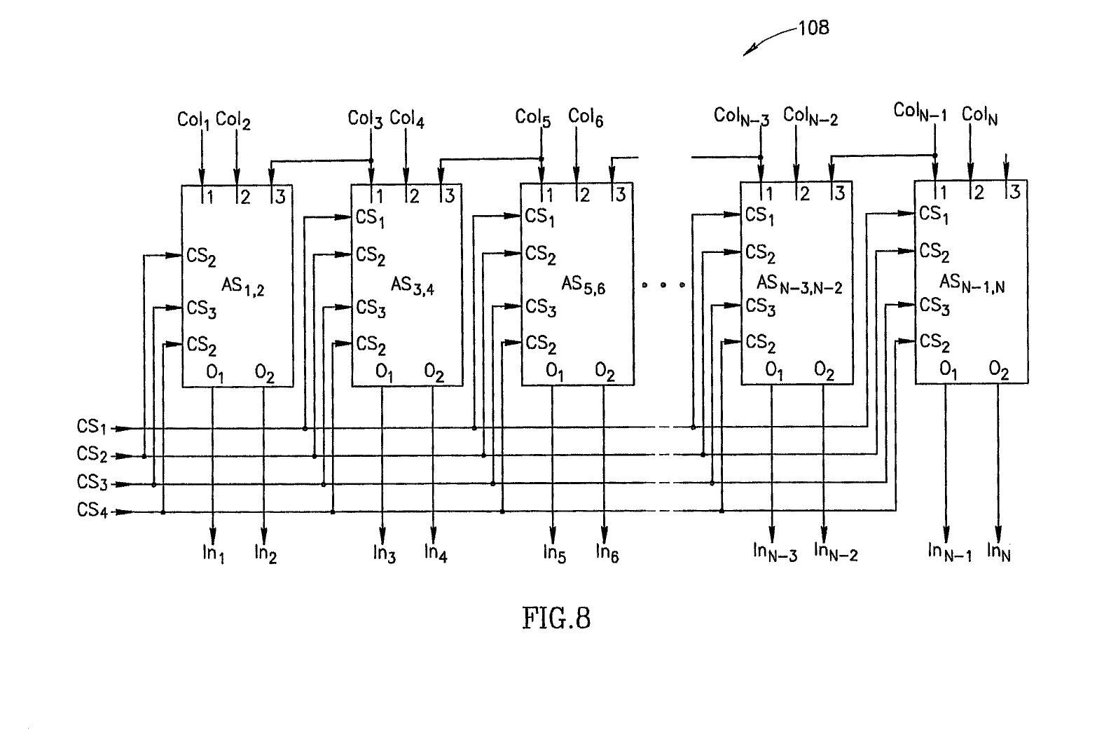

FIG. 7 details line decoders 104 and 106. This decoder is capable of selecting an individual line or selecting a pair of neighboring lines. The decoder comprises a pre-decoder 111 and a plurality of row selectors (RSel) 112. Pre-decoder 111 determines which line pairs to activate while row selectors activate the selected rows.

Pre-decoder 111 has k address inputs and M2 outputs, where k is defined as:

log₂M >k≧log₂M−1

and the output signals are pair line signals Ln_{1,2}, Ln_{2,3}, etc. Pre-decoder 111 selects a line pair and is implemented as a conventional decoder structure.

The output behavior of pre-decoder 111 is defined as:

Let,

i=(LnAdrₖ,LnAdrₖ₋₁, LnAdrₖ₋₂ . . . LnAdr₂,LnAdr₁)₂ (31)

where LnAdri=“0” or LnAdrᵢ=“1”(LnAdrₖLnAdr_{k-I},LnAdrₖ₋₂, . . . LnAdr₂,LnAdr₁)₂ is the binary representation of the integer i and

$$1 \leq i \leq \frac{M}{2}$$

With these conditions, the outputs of pre-decoder 110 are either logical “0” or logical “1” subject to the following:

Ln_{2·i-1,2·i}=En, and (32)

Ln_{2·p-1,2·p} =“0” for p≢i (33)

Thus, if En=0, all of the outputs of line decoder 104 or 106 are logical “0”. In other words, setting En to “0” disables the line read operation This is the default state of line decoders 104/106, when there is no active readout.

The input I of each row selector 112 is connected to one of the outputs Ln_{2p-1,2p} of pre-decoder 111. Each row selector 112 has two outputs O₁ and O₂, which are connected to lines LnRd₂ₚ₋₁ and LnRd₂ₚ, respectively, of array 102 (FIG. 6).

The output signals O₁ and O₂ are functions of input control signals RS₁ and RS₂ and on the input I, driven by the signal Ln_{2j-1,2j}, as defined by Table 2:

TABLE 2

| | |
|---|---|
| Inputs | Ouputs |

| I | RS₁ | RS₂ | O₁ | O₂ |
|---|---|---|---|---|
| “0” | “0” | “0” | Z | Z |
| “1” | “0” | “0” | Z | Z |
| “0” | “0” | “1” | “0” | “0” |
| “1” | “0” | “1” | “0” | “1” |
| “0” | “1” | “0” | “0” | “0” |
| “1” | “1” | “0” | “1” | “0” |
| “0” | “1” | “1” | “0” | “0” |
| “1” | “1” | “1” | “1” | “1” |

Where Z is a high-impedance state also called a tristate.

As can be seen from Table 2, the outputs of a row selector 112 are tristated when control signals RS₁=“0” and RS₂=“0”.The tri-state is used most often for the interlace modes of operation

The combinations in Table 2 can be also described by the following formulas:

$$\begin{matrix}\begin{matrix}{O}_{1} = Z \\ {O}_{2} = '' Z\end{matrix} for {RS}_{1} = '' 0 '' and {RS}_{2} = '' 0 '' , otherwise , & ( 34 ) \\ \begin{matrix}{O}_{1} = {RS}_{1} \cdot I \\ {O}_{2} = {RS}_{2} \cdot I\end{matrix} & ( 35 )\end{matrix}$$

The line decoder output lines values are subject to the following

$$\begin{matrix}\begin{matrix}{LnRd}_{2 \cdot p - 1} = Z \\ {LnRd}_{2 \cdot p} = Z\end{matrix} for {RS}_{1} = '' 0 '' and {RS}_{2} = '' 0 '' , otherwise , & ( 36 ) \\ {LnRd}_{2 \cdot p - 1} = '' 0 '' and {LnRd}_{2 \cdot p} = '' 0 '' for any p \neq i and \\ \begin{matrix}{LnRd}_{2 \cdot p - 1} = {RSel}_{1} \cdot En \\ {LnRd}_{2 \cdot p} = {RSel}_{2} \cdot En\end{matrix} for p = i & ( 37 )\end{matrix}$$

where the function for i is given in (31).

Based upon the values of Rsel₁ and RSel_{2,} line decoders 104 and 106 select either a single line or two lines at a time.

For the highest vertical resolution, when each line is individually read, the line signals LnAdr₁ to LnAdrₖ become active in order, but stay active for a period of two lines. When the odd line is read, RSel₁=“1” and RSel₂=“0”. When the even line is read, RSel₁=“0”¹ and RSel₂=“1”.

When programmed for half the vertical resolution, as described in context with FIGS. 4A and 4C, two lines are read simultaneously and the line signals LnAdr₁ to LnAdrₖ become active in order. During the entire readout, RSel₁=“1” and RSel₂=“1”.

FIG. 8 illustrates programmable column selector 108, which comprises a plurality N/2 of amplifier selectors AS_{2p-,p}p (detailed in FIG. 2), where p is between 1 and N/2, with their inputs connected to the column lines Col₂ₚ₋₁, Col₂ₚ and Col₂ₚ₊₁ and their outputs connected to the inputs In₂ₚ₋₁ and In₂ₚ of sense amplifiers SA_{2-1 p}₁ and SA₂ₚ, respectively. Table 1 hereinabove provides the configurations of amplifier selector AS as functions of the column select signals CS₁ to CS₄ which operate to provide non-interlace or of interlace operation.

For horizontal non-interlace there are two modes, the highest resolution and the half resolution mode, which provides a higher SNR In the highest resolution mode, CS =“1”, CS₂=“1”, CS₃=“0” and CS₄“0”. With these control inputs, each amplifier selector AS_{2p-1,2p} connects column lines Col₂ₚ₋₁ and Col₂ₚ to inputs In₂ₚ₋₁ and In₂ₚ, respectively, of sense amplifiers SA₂ₚ₋₁ and SA₂ₚ and each column is read out separately.

For half resolution, CS₁=“1”, CS₂=“0”, CS₃=“1” and CS₄=“0”. Amplifier selector AS_{2p-1,2p} connects column lines Col₂ₚ₋₁ and Colᵢ₂ₚ to input In₂ₚ₋₁. Inputs In₂ₚ are not utilized and thus, sense amplifiers SA₂ₚ are not active. This configuration supports the modes depicted in FIGS. 4B and 4C.

For horizontal interlace modes, odd columns are read out during the odd field readout and even columns are readout during the even field readout. In this mode, control signals CS₃=“0” and CS₄=“0” for the both fields. During the odd field readout, control signals CSᵢ=“1” and CS₂=“0”, and only the odd columns Col₂ₚ₋₁ are read to the odd-indexed sense amplifiers SA₂ₚ₋₁. Following the readout operation, the outputs of the odd-indexed sense amplifiers are multiplexed to video multiplexer 110. During the even field readout, control signals CS₁=“0” and CS₂=“1”. This results in the even columns Col₂ₚ being read to the even-indexed sense amplifiers SA₂ₚ. Following the readout, the outputs of the even-indexed sense amplifiers SA₂ₚ are multiplexed to the video multiplexer 110. Thus, in this mode of operation, image sensor 100 reads out the odd column pixels during the odd field and the even column pixels during the even field.

For the intercolumn and block interlace modes of FIGS. 5B and 5C, column selector 108 operates as follows: for the odd field readout, control signals CS₁=“1”, CS₂=“0”, CS₃=“1” and CS₄=“0”. Therefore, column fines Col₂ₚ₋₁, and Col₂ₚ are connected to input In₂ₚ₋₁ of sense amplifiers SA₂ₚ₋₁. Sense amplifiers SA₂ₚ are disconnected. The charge from two column lines is steered and added together to a single odd-indexed sense amplifier SA₂ₚ₋₁. For the even field readout, CS₁=“0”, CS₂=“1”, CS₃=“0” and CS₄“1”. Thus, column lines Col₂ₚ and Col₂ₚ₊₁ are connected to the input In₂ₚ of sense amplifier SA₂ₚ. Sense amplifiers SA₂ₚ₋₁ are disconnected. For this field, the charge from two columns is steered and combined at a single even-indexed sense amplifier SA₂ₚ.

FIG. 9 depicts the elements of video multiplexer 110, which comprises a sense amplifier unit 120, a column multiplexer 122 and a column decoder 124.

Sense amplifier unit 120 comprises sense amplifiers SAᵢ, one per column line Colᵢ.

Column decoder 124 controls which sense amplifier SAᵢ connects to a video output line V_{X}. Column decoder 124 outputs a single control output Clᵢ at a time based on an input column address (ColAdr_{L-1},ColAdr_{L-2}, . . . , ColAdr_{2,}ColAdr₁,ColAdr₀)₂ where log₂N≦L ≦log₂N−1.

Thus, if

i=(ColAdr_{L-1}, ColAdr_{L-2}, . . . , ColAdr₂, ColAdr₃, ColAdr₀)₂+1then Clᵢ=“1”, otherwise for j≢i Clⱼ=“0” (38)

Column multiplexer 122 connects the output of sense amplifier SAᵢ to video output line V_{X}. This is performed by activating a per-column transistor CTᵢ whose gate is connected to the per-column output Clᵢ of column decoder 124.

Column selection is controlled thru the column address ColAdr₀-ColAdr_{L-1} and the address logs sequence depends on the desired horizontal resolution.

For the highest resolution, non-interlace mode, the address is incremented by 1 each pixel cycle, starting with (ColAdr_{L-1},ColAdr_{L-2}, . . . , ColAdr₂,ColAdr₁,ColAdr₀)₂=0 and ending with (ColAdr_{L-1},ColAdr_{L-2}, . . . , ColAdr₂,ColAdr₁,ColAdr₀)₂=N. For half the resolution, the address is incremented by 2 each pixel cycle.

The column address sequencing is identical for all interlace modes. During the odd field readout, the address is incremented by 2 each pixel cycle, starting with (ColAdr_{L-1},ColAdr_{L-2}, . . . , ColAdr₂,ColAdr₁,ColAdr₀)₂=0 and ending with (ColAdr_{L-1},ColAdr_{L-2}, . . . ,ColAdr₂,ColAdr₁,ColAdr₀)₂=N. During the even field readout, the address is incremented by 2 each pixel cycle, starting with (ColAdr_{L-1},ColAdr_{L-2}, . . . ,ColAdr₂, ColAdr₁,ColAdr₀)₂=1 and ending With (ColAdr_{L-1},ColAdr_{L-2}, . . . ,ColAdr₂, ColAdr₁,ColAdr₀)₂=N−1.

The image sensor of the present invention can be combined with the programmable resolution method of the invention described in U.S. Ser. No. 09/629,703, filed Jun. 7, 1999, incorporated herein by reference, to accomplish a wider range of resolution/SNR combinations.

The methods and apparatus disclosed herein have been described without reference to specific hardware or software. Rather, the methods and apparatus have been described in a manner sufficient to enable persons of ordinary skill in the art to readily adapt commercially available hardware and software as may be needed to reduce any of the embodiments of the present invention to practice without undue experimentation and using conventional techniques.

It will be appreciated by persons skilled in the art that the present invention is not limited by what has been particularly shown and described herein above. Rather the scope of the invention is defined by the claims that follow:

1. An image sensor comprising:
a plurality of unit cells, each adapted to generate charge in response to photons incident thereon; and
array elements adapted to sum charge from one or more unit cells at a focal plane of said image sensor.

2. An image sensor according to claim 1 and wherein said array elements comprise:
charge transfer transistors, one per unit cell, adapted to transfer charge from their associated unit cells when activated;
a line decoder adapted to activate charge transfer transistors of one or more lines of unit cells; and
a column selector adapted to activate one or more columns of unit cells and to combine the charge transferred by activated charge transfer transistors of said activated columns.

3. An image sensor according to claim 2 and wherein said array elements comprise adjacent line means adapted to indicate to said line decoder to activate at least two adjacent lines and to said column selector to select one column thereby to combine charge from the corresponding unit cells in adjacent lines.

4. An image sensor according to claim 2 and wherein said array elements comprise adjacent column means adapted to indicate to said line decoder to activate one line and to said column selector to combine charge of at least two columns thereby to combine charge from at least two unit cells in adjacent columns.

5. An image sensor according to claim 2 and wherein said array elements comprise block means adapted to indicate to said line decoder to activate U adjacent lines and to said column selector to combine charge of V columns thereby to combine charge from U×V unit cells in a U×V block.

6. An image sensor according to claim 3 and comprising interlace means adapted to produce video output from said image sensor in an interlace mode.

7. An image sensor according to claim 6 and wherein said interlace means comprises means adapted to activate said adjacent line means to combine charge of pairs of unit cells in adjacent lines beginning with the odd lines adapted to an odd field output and of adjacent lines beginning with the even lines adapted to an even field output.

8. An image sensor according to claim 4 and comprising intercolumn means adapted to produce video output from said image sensor in an intercolumn mode.

9. An image sensor according to claim 8 and wherein said intercolumn means comprises means adapted to activate said adjacent column means to combine charge of pairs of adjacent columns beginning with the odd columns adapted to an odd field output and of adjacent columns beginning with the even columns adapted to an even field output.

10. An image sensor according to claim 5 and comprising block interlace means adapted to produce video output from said image sensor in a block interlace mode.

11. An image sensor according to claim 10 and wherein said block interlace means comprises means adapted to activate said block means to combine charge of 2×2 blocks wherein the blocks of an odd field output begin with the block whose upper left-hand unit cell is in the first column, first line and wherein the blocks of an even field output begin with the block whose upper left-hand unit cell is in the second column, second line.

12. An image sensor comprising:
a plurality of unit cells, each adapted to generate charge in response to photons incident thereon; and
array elements adapted to change a resolution of the output of said image sensor at a focal plane of said image sensor.

13. An image sensor according to claim 12 and wherein said array elements comprise:
charge transfer transistors, one per unit cell, adapted to transfer charge from their associated unit cells when activated;
a line decoder adapted to activate charge transfer transistors of one or more lines of unit cells; and
a column selector adapted to activate one or more columns of unit cells and to combine the charge transferred by activated charge transfer transistors of said activated columns.

14. An image sensor according to claim 13 and wherein said array elements comprise adjacent line means adapted to indicate to said line decoder to activate at least two adjacent lines and to said column selector to select one column thereby to combine charge from the corresponding unit cells in adjacent lines.

15. An image sensor according to claim 13 and wherein said array elements comprise adjacent column means adapted to indicate to said line decoder to activate one line and to said column selector to combine charge of at least two columns thereby to combine charge from at least two unit cells in adjacent columns.

16. An image sensor according to claim 13 and wherein said array elements comprise block means adapted to indicate to said line decoder to activate U adjacent lines and to said column selector to combine charge of V columns thereby to combine charge from U×V unit cells in a U×V block.

17. An image sensor according to claim 14 and comprising interlace means adapted to produce video output from said image sensor in an interlace mode.

18. An image sensor according to claim 17 and wherein said interlace means comprises means adapted to activate said adjacent line means to combine charge of pairs of unit cells in adjacent fines beginning with the odd lines adapted to an odd field output and of adjacent lines beginning with the even lines adapted to an even field output.

19. An image sensor according to claim 13 and comprising intercolumn means adapted to produce video output from said image sensor in an intercolumn mode.

20. An image sensor according to claim 19 and wherein said intercolumn means comprises means adapted to activate said adjacent column means to combine charge of pairs of adjacent columns beginning with the odd columns adapted to an odd field output and of adjacent columns beginning with the even columns adapted to an even field output.

21. An image sensor according to claim 13 and comprising block interlace means adapted to produce video output from said image sensor in a block interlace mode.

22. An image sensor according to claim 21 and wherein said block interlace means comprises means adapted to activate said block means to combine charge of 2×2 blocks wherein the blocks of an odd field output begin with the block whose upper left-hand unit cell is in the first column, first line and wherein the blocks of an even field output begin with the block whose upper left-hand unit cell is in the second column, second line.

23. A method comprising:
generating charge in response to photons incident on a plurality of unit cells of an image sensor; and
summing charge from one or more of said unit cells at a focal plane of said image sensor.

24. A method according to claim 23 and wherein said summing comprises:
activating charge transfer transistors of one or more lines of unit cells;
activating one or more columns of unit cells; and
combining the charge transferred by activated charge transfer transistors of said activated columns.

25. A method according to claim 23 wherein said summing comprises activating at least two adjacent lines and selecting one column thereby to combine charge from the corresponding unit cells in adjacent lines.

26. A method according to claim 23 and wherein said summing comprises activating one line and combining charge of at least two columns thereby to combine charge from at least two unit cells in adjacent columns.

27. A method according to claim 23 and wherein said summing comprises activating U adjacent lines and combining charge of V columns thereby to combine charge from U×V unit cells in a U×V block.

28. A method according to claim 25 and comprising producing video output from said image sensor in an interlace mode.

29. A method according to claim 28 and wherein said producing comprises combining charge of pairs of unit cells in adjacent lines beginning with the odd lines for an odd field output and of adjacent lines beginning with the even lines for an even field output.

30. A method according to claim 26 and comprising producing video output from said image sensor in an intercolumn mode.

31. A method according to claim 30 and wherein said producing comprises combining charge of pairs of adjacent columns beginning with the odd columns for an odd field output and of adjacent columns beginning with the even columns for an even field output.

32. A method according to claim 31 and comprising producing video output from said image sensor in a block interlace mode.

33. A method according to claim 32 and wherein said producing comprises combining charge of 2×2 blocks wherein the blocks of an odd field output begin with the block whose upper left-hand unit cell is in the first column, first line and wherein the blocks of an even field output begin with the block whose upper left-hand unit cell is in the second column, second line.

34. A method comprising:
generating charge in response to photons incident on a plurality of unit cells of an image sensor; and
changing a resolution of the output of said image sensor at a focal plane of said image sensor.

35. A method according to claim 34 and wherein said changing comprises:
activating charge transfer transistors of one or more lines of unit cells;
activating one or more columns of unit cells; and
combining the charge transferred by activated charge transfer transistors of said activated columns.

36. A method according to claim 34 wherein said changing comprises activating at least two adjacent lines and selecting one column thereby to combine charge from the corresponding unit cells in adjacent lines.

37. A method according to claim 34 and wherein said changing comprises activating one line and combining charge of at least two columns thereby to combine charge from at least two unit cells in adjacent columns.

38. A method according to claim 34 and wherein said changing comprises activating U adjacent lines and combining charge of V columns thereby to combine charge from U×V unit cells in a U×V block.

39. A method according to claim 36 and comprising producing video output from said image sensor in an interlace mode.

40. A method according to claim 39 and wherein said producing comprises combining charge of pairs of unit cells in adjacent lines beginning with the odd lines for an odd field output and of adjacent lines beginning with the even lines for an even field output.

41. A method according to claim 37 and comprising producing video output from said image sensor in an intercolumn mode.

42. A method according to claim 41 and wherein said producing comprises combining charge of pairs of adjacent columns beginning with the odd columns for an odd field output and of adjacent columns beginning with the even columns for an even field output.

43. A method according to claim 42 and comprising producing video output from said image sensor in a block interlace mode.

44. A method according to claim 43 and wherein said producing comprises combining charge of 2×2 blocks wherein the blocks of an odd field output begin with the block whose upper left-hand unit cell is in the first column, first line and wherein the blocks of an even field output begin with the block whose upper left-hand unit cell is in the second column, second line.
